(19) United States
(12) Patent Application Publication
(10) Pub. No.: US 2006/0283219 A1
(43) Pub. Date: Dec. 21, 2006

(54) Device at lock

(76) Inventors: David Bendz, Hovas (SE); Patric Linder, Goteborg (SE); Akerskog Lars, Orrebacksgatan (SE)

Correspondence Address: NIXON & VANDERHYE, PC, 901 NORTH GLEBE ROAD, 11TH FLOOR, ARLINGTON, VA, 22203, US

(21) Appl. No.: 10/570,253

(22) PCT Filed: Sep. 3, 2004
(86) PCT No.: PCT/SE04/01269

§ 371 Date: Mar. 2, 2006

(30) Foreign Application Priority Data
Sep. 4, 2003 (SE) 0302364.5

(51) Int. Cl. E05B 17/00

(52) U.S. Cl. 70/431

(57) ABSTRACT

The present invention relates to an arrangement for a lock (2) for doors (3).

An electromechanical unit (6), with an integral electrically driven stepping motor (7), which is intended to operate the lock handle by actuation of the motor (7), is capable of being applied to the inside (3A) of the door (3).

An electronic unit, which is capable of being actuated by an electronic key, is capable of being mounted on the outside of the door (3), which unit is so arranged as to interact with a magnetic field with a predetermined frequency and by wireless communication between the key and the unit.

A power supply unit is provided, and a central processor unit is so arranged as to monitor the aforementioned electromechanical unit (6) and an RFID reader contained in the electronic unit.

Arranged between the motor (7) and the lock (2) is a rotating driver (13) for transferring the force from the motor (7) to the lock (2).

The present invention relates to an arrangement for sensing the position of the lock bolt in a lock intended for the door to an apartment, for example, which lock comprises an internal lock handle, a lock bolt, a driver arranged between a motor and the lock for the transfer of force from the motor to the lock and a number of gear wheels.

Previously disclosed are motorized locks, for example for doors, which are so arranged as to be caused respectively to be locked and unlocked with the help of contactless electronic keys, for example tags, which are in communication with a lock control centre, in which an RFID reader is included.

The method of sensing the position of a lock bolt with the help of one or more Hall elements is already familiar. In previously disclosed arrangements, these sensors are placed directly adjacent to the lock mechanism, either inside the lock casing by the manufacturer of the lock or externally in the striking plate on the door frame, which requires the routing of cables between the door frame and the control system. It is customary in the automobile industry to use arrangements which make use of magnets and Hall elements in order to sense the position in which the ignition key is situated.

Described in U.S. Pat. No. 6,223,571 B1, for example, is a system which senses a number of predetermined positions between its Hall elements and a magnet and acts directly in response to this, for example by starting an engine. It functions quite simply as a mechanical switch with fixed positions, for which it acts as a functional replacement. See also U.S. Pat. No. 6,067,824 A, which relates to a similar system.

Described in U.S. Pat. No. 5,890,384 A and WO 01/00462 A1 are arrangements which use Hall elements in order to sense the position of the lock bolt in a vehicle door.

The purpose of the arrangement in U.S. Pat. No. 5,862,691 A is to ensure that the predetermined positions in a lock with Hall elements cannot be manipulated from outside with a powerful magnet. The function is otherwise similar to that described in U.S. Pat. No. 6,223,571 B1, that is to say it directly replaces the function of a mechanical switch with predetermined fixed positions.

In all the above-mentioned documents, sensing takes place directly, regardless of whether it is concerned with determining the position of the ignition key or the position of the lock bolt.

An RFID reader is constituted by an electronic unit, the purpose of which is to generate a magnetic field with a specific frequency, which in turn is capable of inductively activating an electronic key in order subsequently to establish wireless communication between them. Communication is only possible when the key is present in the magnetic field. However, the lock and the associated inspection and control means are designed and constructed to function solely as a so-called motorized lock. This means that it is necessary to replace existing locks, instead of being able to convert the lock to enable it to function as a so-called motorized lock, which is controlled by keyless influence. For all types of motorized lock, it is necessary for the position of the lock bolt to be known at all times by the control electronics. This is particularly important in order to be able to establish whether or not the lock has actually locked.

The principal object of the present invention is, in relation to an arrangement of the above-mentioned kind, indirectly to detect the position of a lock bolt, which does not necessarily correspond directly to a given position between the Hall elements and the magnet. Indirect sensing in this case means: sensing of a mechanical position (the lock bolt) in a closed system (the lock casing in the door) other than the system which records the sensing (the lock motor), and that the sensing is not performed directly on the part that is the object of the sensing (the lock bolt).

The aforementioned object is achieved by means of an arrangement in accordance with the present invention, which is characterized essentially in that a number of sensors is attached adjacent to one of the gear wheels for detecting the position of the lock bolt.

The invention is described below as a number of preferred illustrative embodiments with reference to the accompanying drawings, in which

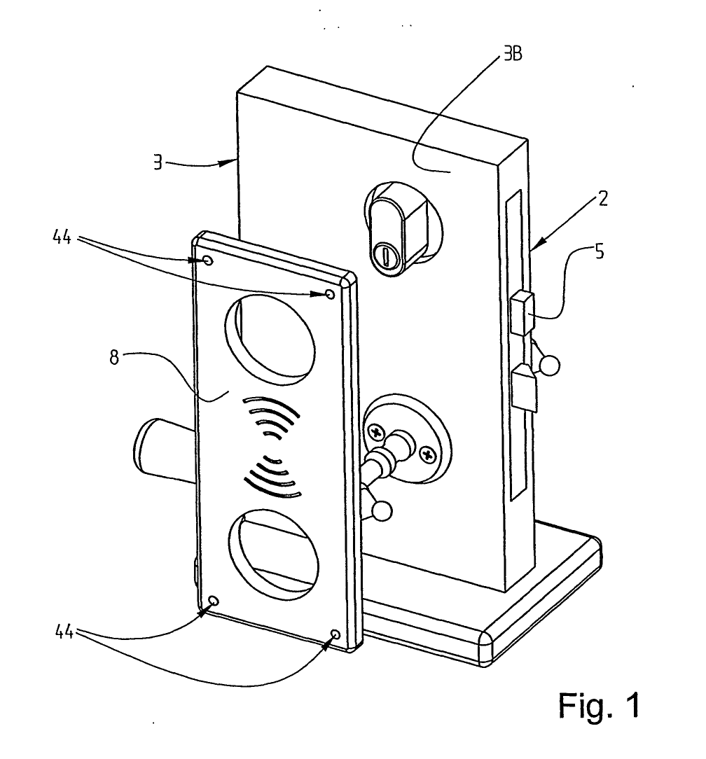

FIG. 1 shows a lock on a door viewed from outside and shown partly as an exploded view;

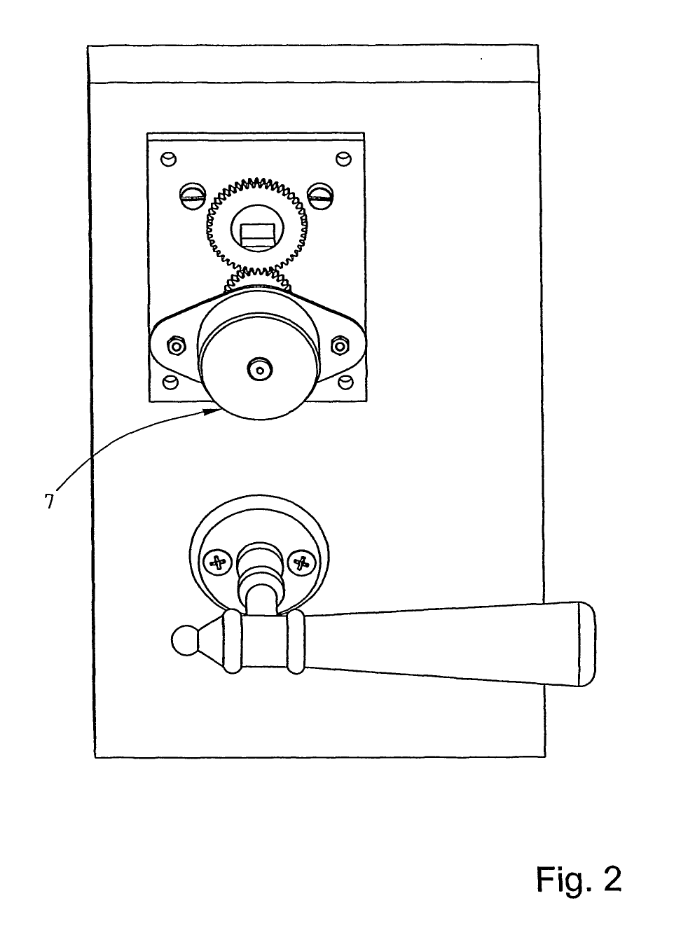

FIG. 2 shows the lock viewed from the inside of the door and with the cover panel removed;

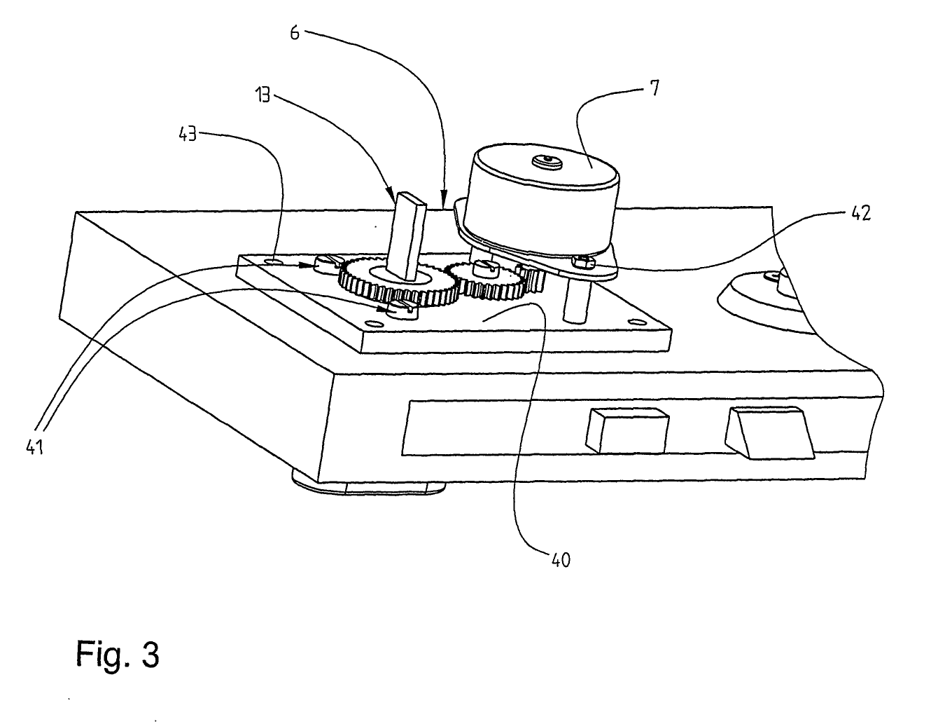

FIG. 3 shows a perspective view of an electromechanical unit included in the arrangement;

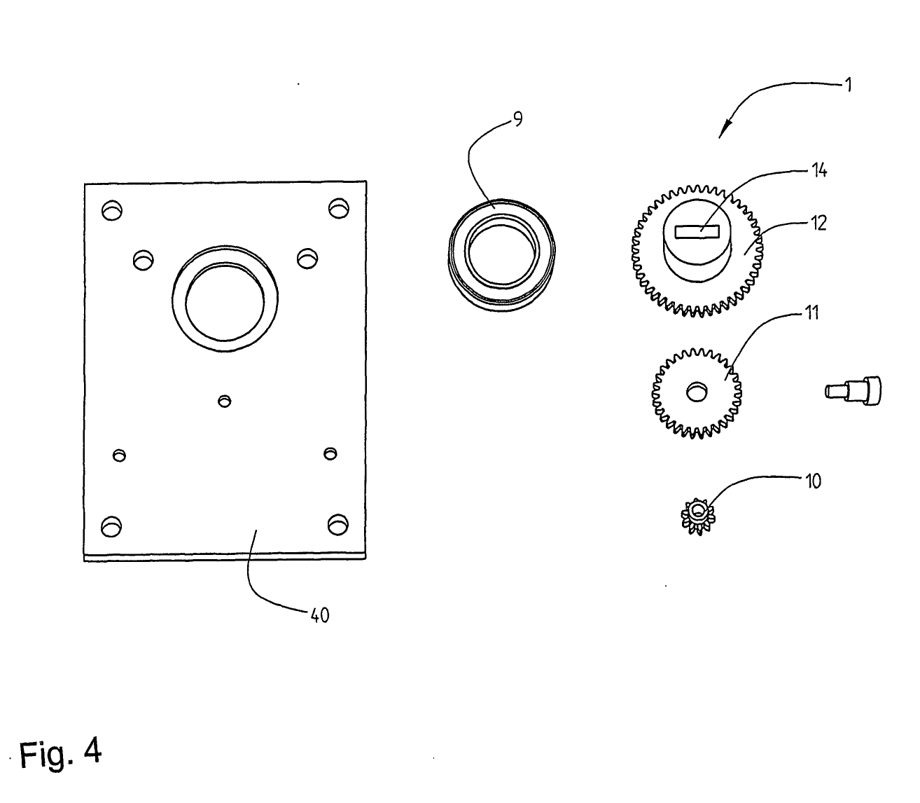

FIG. 4 shows a plan view of parts included in the aforementioned unit;

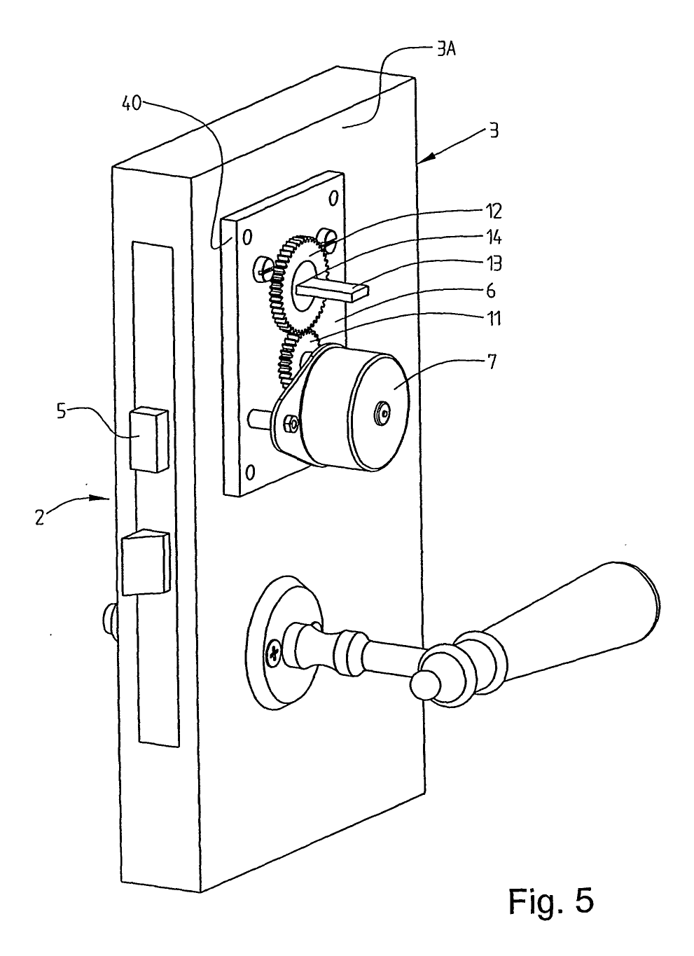

FIG. 5 shows the lock and the unit viewed at an angle from the outer edge of the door;

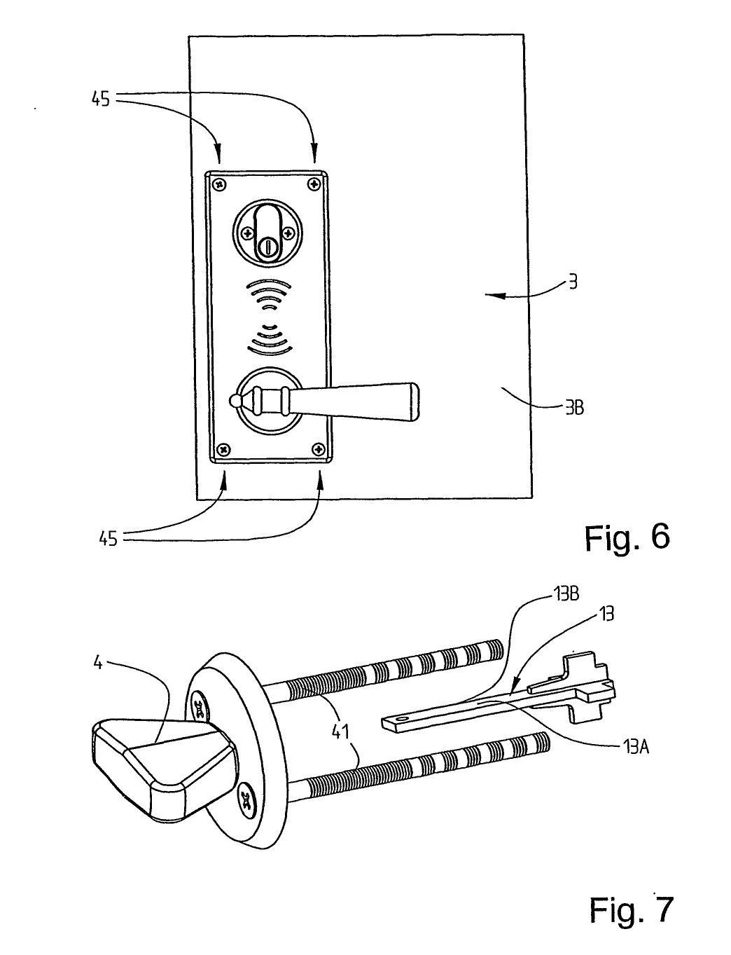

FIG. 6 shows a door and a lock viewed from outside;

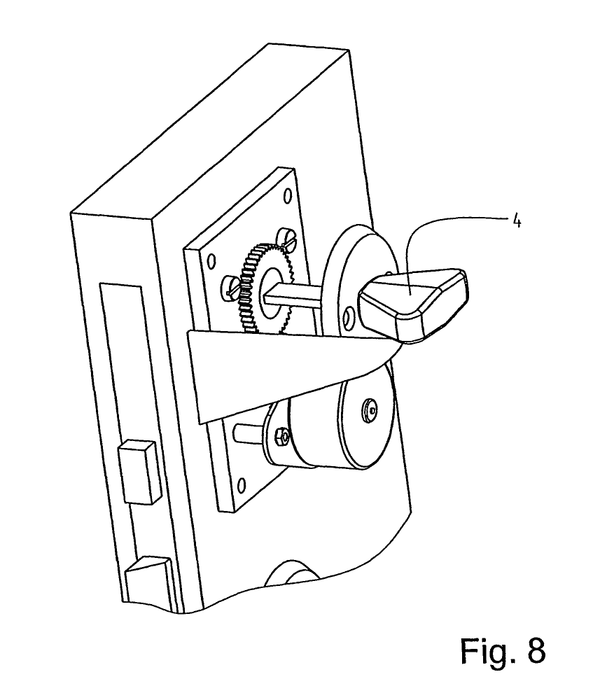

FIG. 7 shows a handle and a driver and their associated fixing screws;

FIG. 8 shows the handle in the installed position;

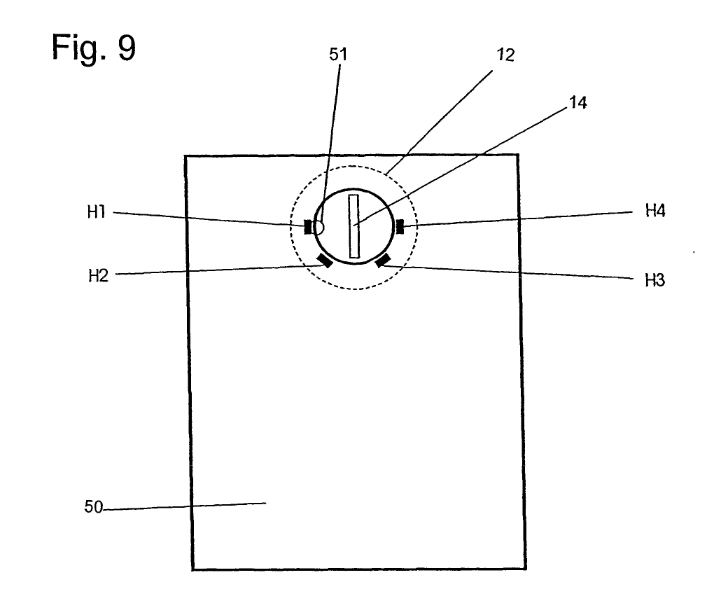

FIG. 9 shows the positions of the sensors in relation to the magnet, viewed from above; and

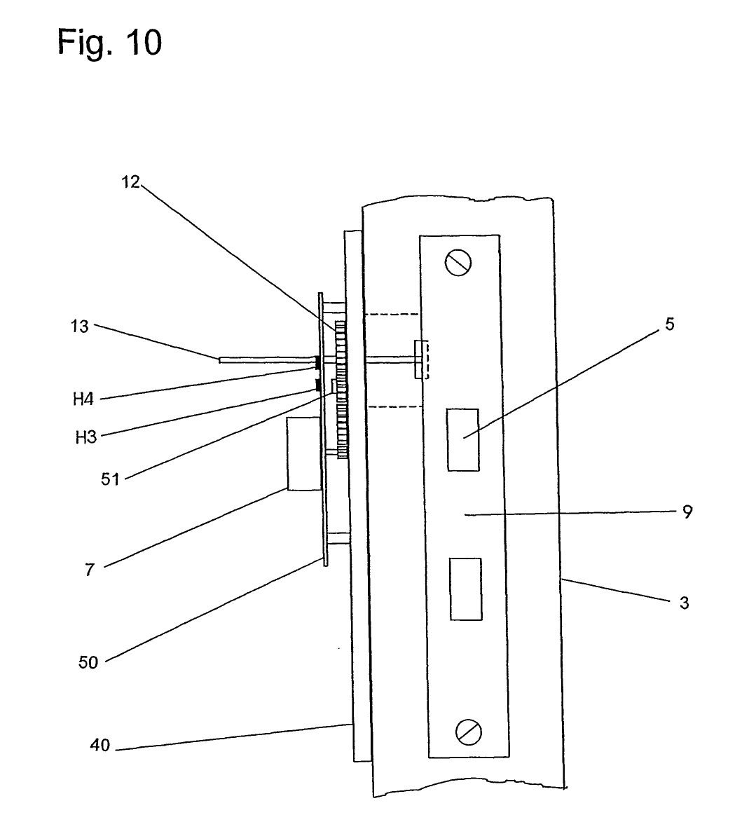

FIG. 10 shows a lock motor, without its cover and without the normal door handle, mounted on a door.

The invention relates to an arrangement 1, which is intended to be capable of connection to existing, pre-installed or other standard locks 2, and which is intended for an apartment door 3, for example, comprising an internal lock handle 4 and a lock bolt 5.

In accordance with the invention, an electromechanical unit 6, which comprises an integral electrically driven stepping motor 7, which is intended to actuate the lock handle 4 under the influence of the motor 7, is capable of being applied to the inside 3A of the door 3, for example as shown in FIG. 5.

An electronic unit 8, which is capable of being actuated by an electronic key, is capable of being mounted on the outside 3B of the door 3. The aforementioned unit 8 is so arranged as to interact with a magnetic field, which exhibits a particular frequency, and by wireless communication between a key (not shown here) and the aforementioned unit 8. A power supply unit is also provided as well as a central processor unit (not shown), which is so arranged as to monitor the aforementioned electromechanical unit 6, and an RFID reader contained in the electronic unit 8. Arranged between the motor 7 and the lock 2 is a rotating driver 13 for transferring the force from the motor 7 to the lock.

Described below in greater detail is an electromechanical unit with an integral motor intended to actuate the lock handle, for example in an apartment door, on an existing standard apartment lock, for example of the type ASSA 8765.

The purpose of the whole arrangement is to obtain the function of a complete motorized lock by simple and inexpensive means, whereby the aforementioned unit provides the electromechanical control and the existing lock provides the actual lock mechanism, and to be able to sense whether the door 3 is fully closed and whether the lock bolt 5 is in the retracted or extended position. No modification is required to the existing lock. The only necessary addition to the lock is a longer driver and two longer fixing screws. The unit is mounted on the inside of the door between the lock handle of the existing lock and the door itself. The existing lock handle is mounted on top of the unit with the help of the extended fixing screws.

The motorized lock described above is intended to be included in a system, which is under the overall control of a central unit known as the central processor unit. Important constituent parts of the system, apart from the motorized lock and the central processor unit, are an RFID reader (reader) and a power supply unit. The purpose of the entire system is to avoid the need to use keys for the apartment doors. Instead of a key, a contactless electronic “key” (tag) is used containing a unique code, which is read by the RFID reader when the owner holds his “key” in front of the reader. The RFID reader can be screwed securely to the outside of the door directly over the lock.

The electromechanical unit 6 comprises a number of gear wheels 10, 11, 12, of which one gear wheel 12 accommodates a central part 13A of a driver 13 executed as a flat rotating shaft in an elongated hole 14. The aforementioned electromechanical unit 6 is accommodated by a bottom plate 40 made of metal capable of being attached to the door 3 and with a protective enclosure made of metal (not shown) over the parts that are present thereon.

The aforementioned manually actuated lock handle 4 is attached to the driver 13, more particularly to its free end 13B, and the aforementioned bottom plate 40.

The power transmission consists of three gear wheels 10-12 contained in a gearbox in order to obtain the necessary force to cause the driver 13 of the lock to rotate. Belt pulleys, for example, can be used in place of gear wheels. The first gear wheel 10 sits on the motor shaft. An intermediate gear wheel 11 is provided in order to obtain a sufficient distance between the motor and the driver. The last gear wheel 12 has a transcurrent rectangular hole 14, through which the driver 13 is inserted in conjunction with assembly of the unit 6 on the door 3 and in this way will cause the driver 13 to rotate when the motor 7 is activated. The last gear wheel 12 is glued in a bearing 9 (ball bearing) to enable it to be caused to rotate. The ball bearing 9 is attached to the bottom plate 40 in the enclosure.

The gear reduction achieved by the gear wheels 10-12 is selected so that sufficient force is available at the last gear wheel 12 without at the same time there being excessive inertia for the whole assembly to be rotated backwards with the help of the lock handle 4 when the lock 2 is actuated manually. The total gear reduction is six fold.

Small high-speed servomotors with a screwed-on gearbox are used in a conventional motorized lock. This arrangement has two weaknesses, which are neutralized in the present unit 6. A high gear reduction, of the order of 50-100 fold, is required because of the high speed of the motor, which results in the need for small mechanical dimensions in order to be able to accommodate everything in a very limited space. The first weakness is that the gearbox with its associated motor is expensive. The second is that the small dimensions of the gearbox mean that it is mechanically fragile by necessity, which is manifested when the bolt of the lock makes abrupt contact with, for example, the striking plate of the door frame in the event of a failed attempt at locking. Special mechanical solutions must be used in order to mitigate the effect of the strong forces that arise inside the gearbox in conjunction with such highly abrupt deceleration. The high gear reduction also means that problems with very high speeds of rotation occur in the motor, since the whole assembly must be rotated backwards when the lock handle is rotated manually.

The motor 7 in the present unit 6 is preferably a stepping motor. This has the advantage of being inexpensive, and it lends itself to speed control in a very direct fashion without the need for an expensive and mechanically fragile gear reduction. This type of motor has a characteristic feature which is very often regarded as negative, but which is turned to an advantage in this case. When the motor encounters excessive resistance, it loses its turning moment monetarily and instantaneously, which means that it can no longer transmit any destructive force. It is precisely this characteristic that is sought in the event of such a highly abrupt stop.

Thanks to the direct speed control of the stepping motor and its relatively high underlying torque, only a relatively modest gear reduction of a given basic speed is required in order to obtain the necessary force. The gear reduction in its entirety can accordingly be made compact and with suitably dimensioned gear wheels and shafts which are able to withstand the forces generated by abrupt deceleration.

Holes 44 for the fixing screws of the RFID reader are also shown in FIG. 1, and the two fixing screws 41 for the handle and a fixing screws 42 for the motor are shown in FIG. 3. Holes 43 for fixing the plate 40 with screws are also shown in FIG. 3. Fixing screws 45 for the attachment of the RFID reader are also shown in FIG. 6.

An electronic connection is required in order to be able to control the motor 7, read the sensors, receive commands to activate the motor 7, and report the status of the lock. This electronic connection is positioned inside the same enclosure as the motor 7 and the power transmission. The electronics communicate directly with the central processor unit and only activate the motor control once the central processor unit has approved this.

Sensors or transducers are required in order to be able to establish whether the door 3 is fully closed and whether the lock bolt 5 is fully extended from or fully retracted into the lock. The unit 6 must only activate the motor 7 when the door 3 is fully closed. A magnetic contact positioned in the door frame is used for this purpose.

In order to be able to determine electronically whether the lock bolt in a door lock is locked or unlocked, some form of sensor/transducer is required which is capable of reading the position of the lock bolt directly or indirectly, that is to say whether it is in a retracted position (unlocked) or in an extended position (locked).

An entirely new arrangement must be developed in order for this to be feasible in a simple fashion without having either to modify the standard lock or to position external sensors. This arrangement, see FIGS. 9 and 10, functions by indirectly sensing the position of the lock bolt 5 with the help of a number of sensors H1, H2, H3, H4 and a magnet 51, and is described below. The aforementioned sensors preferably consist of Hall elements.

FIG. 9 shows the positions of the Hall elements H1-H4 in relation to the magnet 51, viewed from above. The Hall elements H1-H4 together with all the other necessary electronics are mounted on a circuit board 50. The circuit board 50 is permanently mounted on a bottom plate 40. The bottom plate 40 is mounted on the door 3 on which the lock motor will be mounted. The magnet 51 is mounted on the gear wheel 12 which causes the driver 13 to rotate.

FIG. 10 shows the lock motor, without its cover and without the standard door handle, mounted on a door 3, all viewed from the side. Note that the driver 13 is not included in the lock motor. It is a separate standard component that is connected between the lock motor and the lock in the door.

The motor 7 that is present inside the enclosure in the arrangement actuates the driver 13 of the lock via a number of gear wheels 10-12. A small magnet 51 is located on the gear wheel 12 that is in direct contact with the driver. The location of the magnet 51 can also be effected on, for example, the driver 3 or one of the other gear wheels 10, 11. The selected gear wheel 12 represents the optimal solution in this context, however. When the driver 13 is caused to rotate, either by manual actuation or by being actuated by the motor 7, the magnet 51 will also be caused to rotate because the gear wheel 12 is always in direct contact with the driver 13. The driver 13 is, in actual fact, a loosely connected shaft which passes all the way through the gear wheel 12. If a number of Hall elements H1-H4 is placed directly above the envisaged path of the magnet 51 and at strategic points, for example, the Hall elements H1-H4 can indicate the positions on the rotating path of the driver 13 which correspond to the reversal positions of the lock bolt 5. Since the sole function of the driver 13 is to transmit a rotating force in order to be able respectively to lock and unlock the lock in the door 3, it is thus possible by this indirect means to sense the position of the lock bolt 5, i.e. whether the lock is unlocked or locked.

Sensing is used in the arrangement in order to sense the position in which the lock bolt 5 finds itself on the one hand in an indirect fashion and, on the other hand, to determine whether the lock is subject to inertia (“inertia sensing”) or if the lock bolt 5 has jammed. Sensing also functions as a safety mechanism to prevent the activated motor 7 from remaining activated for an excessively long period when the lock bolt 5 has become jammed, and it also tells the control electronics when the right lock bolt position has been reached when actuation of the lock bolt 5 is effected with the help of the motor 7. In order to be able to determine the position of the lock bolt 5 when the handle on the lock is actuated manually, all the Hall elements H1-H4 are read continuously. In this way, the control electronics are aware at all times whether the lock is locked or unlocked, regardless of whether the lock bolt has been actuated manually or with the help of the lock motor 7 (motor control). The entire procedure takes place in such a way that no external sensors are required in order to detect the position of the lock bolt 5. All the Hall elements H1-H4 are positioned inside the same enclosure that is constituted by the lock motor 7. No modification is required to the existing lock for all of this to function as described above.

Hall elements H1 and H4 are used for motor control, and H2 and H3 are used to sense the position of the lock bolt in conjunction with manual locking/unlocking.

A computer program for controlling the control electronics must always be installed; this uses one or more algorithms to enable it finally to determine the position of the lock bolt. Rotation of the driver can, in fact, be executed so that the magnet moves past the respective Hall element, but without the lock bolt having changed its position for that reason. It is thus not possible to state that a given Hall element corresponds to an exact position for the lock bolt.

All the Hall elements are used for sensing in conjunction with “inertia sensing”.

The motor 7 causes the driver 13 of the lock to rotate with the help of the gear wheel 12. The driver passes through the elongated hole 14 in the gear wheel. The driver in turn causes a mechanism in the lock casing to rotate, which finally causes the lock bolt 5 of the lock to move. In order to be able to determine the position of the lock bolt 5 without having any form of external sensor, a magnet 51 is used which is mounted on a gear wheel 12. The position of the magnet 51 is determined by the Hall elements H1-H4 that are located on the circuit board 50 of the lock motor. The circuit board 50 contains all the necessary electronics for reading the Hall elements H1-H4 and controlling the motor 7. A total of four Hall elements is preferably used for position sensing and “inertia sensing”. The reason why four Hall elements are required rather than two is because this gives greater reliability in conjunction with motorized locking. This in turn derives from the fact that, in conjunction with manual rotation, the handle is rotated until the lock bolt reverses and the user hears this and accordingly stops rotating the handle. This gives rise to two reversal positions, which are situated relatively close to one another. When account is taken of various mechanical tolerances in the lock, carelessness in the assembly of the lock motor and scatter in the detection range of the Hall elements, it will be appreciated that the above-mentioned reversal positions cannot be used in conjunction with motorized locking, since the various positions can be reached without the lock bolt having locked or unlocked for that reason. Sensors are required, therefore, which cause the lock motor to rotate the driver past the respective manual reversal positions. The manual positions must be retained, however, because a user who rotates the handle manually will still only rotate the handle precisely to the point at which the lock bolt reverses.

The Hall elements H1-H4 must not necessarily be mounted on a circuit board 50 above the magnet 51. They can be mounted in a different way, although they must still be mounted sufficiently close to the magnet to permit sensing to take place. In order for the whole to function, some form of control electronics with an associated computer program must be provided. These control electronics can be contained with advantage in the same enclosure as the mechanical parts, although this is not essential.

“Inertia sensing” is one means by which the control electronics in the lock motor can determine the time taken respectively to lock and unlock the lock. This is done by sensing the time taken to rotate the magnet from one Hall element with a given position to the next one. Different time criteria must be met during the actual motorized locking procedure. These criteria are dependent on the position that is the starting point. Failure to meet certain of the criteria will stop the motor, and a number of repeated attempts to lock or unlock will be initiated. If other criteria are not met, which mean that the lock is locked or unlocked, but if it takes too long to do this, this will be reported to a host system, which in turn will store the incident in its memory. These incidents can then be read by a user at a central level and, for example, they can serve as the basis for remedial adjustments to the arrangements that exhibit problems.

In order respectively to lock and unlock a lock of the type ASSA 8765 manually, for example, it is necessary for the carrier to be rotated through ca 100 degrees from a given locked or unlocked position to the opposite position. For the purpose of motor control, the rotation must be greater in order to be able to guarantee that the lock has really changed status from locked/unlocked to the opposite status. In this case a rotation of ca 180 degrees is considered to be sufficient. Types of lock other than ASSA 8765, for example, may require different positions for the Hall elements in order to sense the reversal positions, although the method remains the same.

In both cases, it is necessary to cause the driver to rotate until the lock bolt of the lock has changed its position either from fully locked to fully unlocked, or vice versa. A 180-degree rotation of the driver is not normally executed in the case of manual rotation, as this is not necessary—the person who rotates the handle rotates it only until the lock bolt has changed position, since audible feedback occurs on reversal.

It should be possible to utilize this feedback in an envisaged application by using a microphone as a sound recording device and by this means being able to identify the reversal between a fully unlocked lock and a fully locked lock. This method nevertheless suffers from the disadvantage that it is easy to disrupt, for example, if someone mistakenly pulls at the door at the same time as the lock is in the process of locking.

It is thus necessary in the case of manual rotation for the driver to be caused to rotate via the handle that is mounted on the enclosure of the lock motor, in such a way that H1 and H4 will very often not be able to sense the position of the magnet. In order to be able to determine the position of the lock bolt in conjunction with manual rotation, a further two Hall elements must be used. These are designated as H2 and H3 in FIGS. 9 and 10. H2 and H3 are positioned in such a way that, in conjunction with manual rotation, they indicate the position of the lock bolt with the lock bolt out (locked lock) or with the lock bolt in (lock unlocked).

Since mechanical tolerances, carelessness in assembly and even scatter in the detection range of the Hall elements must not be allowed to influence security, in particular in conjunction with locking with the help of motorized control, Hall elements H1 and H4 must be used in conjunction with motorized control. If only Hall elements H2 and H3 were to be used, it would not be possible with any certainty to determine, for example, the correct position of a locked lock bolt, for the simple reason that H2, for example, could give an indication of a locked bolt before the bolt had actually locked. The fact that H1 and H4 are present obliges the control program in the electronics to actuate the driver so that the lock “over-locks” (H1) and “over-unlocks” (H4).

By using four Hall elements as described above, it is possible to limit the time for which the motor and the mechanics are subjected to abnormally high loads in those cases in which the lock bolt binds or has become jammed. If the starting position is H4 (locked lock), for example, and if the motor must cause the magnet to rotate to Hi (lock unlocked), this means that a 180-degree rotation must be executed. With only two Hall elements (H1 and H4), the time normally taken to rotate the driver through 180 degrees must have elapsed before the control program which controls the motor is able to react to the possibility that the lock bolt has become jammed.

By using H2 and H3 instead, it is possible to discover very much earlier whether the lock bolt has become jammed, quite simply by measuring the time between, for example, H4 and H3 and between H3 and H2 and between H2 and H1. The measured times can then be used to determine whether the lock has become jammed or is simply binding. This is known as inertia sensing.

It is entirely conceivable for sensors other than Hall elements to be used to sense the position of the lock bolt as described above. This may be done, for example, with the help of optical sensors and/or micro switches. Hall elements nevertheless have the advantage that they are insensitive to dust and dirt, and that they do not possess a mechanical function. The choice of motor is of no significance for the function, of course, with indirect sensing of the position of the lock bolt. It is possible, for example, to use a stepping motor, a servomotor or any other form of electric motor, although a stepping motor possesses certain advantages which the other motors do not have.

All the above-mentioned parts can be positioned inside one and the same enclosure made of metal.

The design of the enclosure is such that, in addition to being attached to the two screws of the handle, it also engages with the four fixing screws of the RFID reader coming from the outside of the door. This ensures a very stable attachment of the unit. The RFID reader and the unit are thus positioned to either side of the door lock.

The invention is naturally not restricted to the illustrative embodiments described above and illustrated in the accompanying drawings. Modifications are possible, in particular with regard to the nature of the various parts, or by the use of equivalent technology, without departing from the area of protection afforded to the invention, as defined in the Patent Claims.

1. Arrangement (1) for sensing the position of the lock bolt (5) in a lock (2) intended for the door (3) to an apartment, for example, which lock comprises an internal lock handle (4), a lock bolt (5), a driver (13) arranged between a motor (7) and the lock (2) for the transfer of force from the motor (7) to the lock (2) and a number of gear wheels (10-12), characterized in that the arrangement is capable of being connected to an existing lock (2), an electromechanical unit (6), with an integral electrically driven motor (7), which is intended to operate the lock handle (4) by actuation of the motor (7), is capable of being applied to the inside (3A) of the door (3), in conjunction with which there is arranged between the motor (7) and the lock (2) a rotating driver (13) for transferring the force from the motor (7) to the lock (2), in that the aforementioned manually actuated lock handle (4) is attached to the driver (13), in that the lock handle (4) is attached to the free end (13B) of the driver (13), in that the motor (7) is a stepping motor and in that a number of sensors (H1-H4) is attached in conjunction with one of the gear wheels (10-12) for detecting the position of the lock bolt (5).

2. Arrangement in accordance with Patent claim 1, characterized in that a magnet (51) is attached to one of the gear wheels (10-12), and in that the aforementioned sensors consist of a number of Hall elements (H1-H4) which are attached adjacent to the aforementioned gear wheels (10-12) for detecting the position of the magnet (51).

3. Arrangement in accordance with claim 1, characterized in that the magnet (51) is attached to the gear wheel (12) which accommodates a part (13A) of a driver (13) executed as a flat rotating shaft in an elongated hole (14).

4. Arrangement in accordance with claim 1, characterized in that, an electronic unit (8), which is capable of being actuated by an electronic key, is capable of being mounted on the outside (3B) of the door (3), which unit is so arranged as to interact with a magnetic field with a predetermined frequency and by wireless communication between the key and the unit (8),
a power supply unit is also provided,
a central processor unit is so arranged as to monitor the aforementioned electromechanical unit (6) and an RFID reader contained in the electronic unit (8),

5. Arrangement in accordance with Patent claim 4, characterized in that the electromechanical unit (6) is accommodated by a bottom plate (40) capable of being attached to the door (3) and with a protective enclosure for the parts that are present thereon.

6. Arrangement in accordance with Patent claim 5, characterized in that the aforementioned bottom plate (40) and the RFID reader are attached to the door with common fixing screws.

7. Arrangement in accordance with claim 1, characterized in that the number of sensors are at least two.

8. Arrangement in accordance with Patent claim 7, characterized in that the number of sensors are four.

9. Arrangement in accordance with Patent claim 2, characterized in that the Hall elements (H1-H4) are mounted on a circuit board (50).
